(19) United States
(12) Patent Application Publication
(10) Pub. No.: US 2009/0135743 A1
(43) Pub. Date: May 28, 2009

(54) METHOD FOR THE CONDITIONAL SETTING-UP OF A TELECOMMUNICATION CONFERENCE SESSION, TELECOMMUNICATION CONFERENCE ARRANGEMENT AND TELECOMMUNICATION CONFERENCE SESSION SERVER

(75) Inventor: Frank Kowalewski, Unterhaching (DE)

Correspondence Address: Viering, Jentschura & Partner, 3770 Highland Ave., Suite 203, Manhattan Beach, CA, 90266, US

(73) Assignee: Infineon Technologies AG, Neubiberg (DE)

(21) Appl. No.: 12/269,897

(22) Filed: Nov. 13, 2008

(30) Foreign Application Priority Data
Nov. 26, 2007 (DE) 10 2007 056 725.3

(51) Int. Cl. H04Q 11/00; G06F 15/16

(52) U.S. Cl. 370/261; 709/204

(57) ABSTRACT

In a method for the conditional setting-up of a telecommunication conference session with a multiplicity of telecommunication conference session user terminals, wherein a group of user terminals having at least one telecommunication conference session user terminal is identified by means of a telecommunication conference session user group identification, a predefined telecommunication conference session set-up condition is checked by involving two telecommunication conference session servers. A first telecommunication conference session server receives an enquiry for the conditional setting-up of a telecommunication conference session and a second telecommunication conference session server determines condition-related information for checking the predefined telecommunication conference session set-up condition.

### CROSS-REFERENCE TO RELATED APPLICATION

This application claims priority to German Patent Application Serial No. 10 2007 056 725.3, which was filed Nov. 26, 2007, and is incorporated herein by reference in its entirety.

### TECHNICAL FIELD

Embodiments relate to a method for the conditional setting-up of a telecommunication conference session, to a telecommunication conference arrangement and to a telecommunication conference session server.

### BACKGROUND

In a conference system the right to communicate (access right) is usually controlled by means of an access right allocation mechanism. In the context of this mechanism, the user requests an access right from a telecommunication conference server and the server grants the right or does not grant it.

In general, conference systems make it possible to communicate between several users with the aid of communication devices.

To provide for orderly communication, not all users in a conference normally get the right at the same time to communicate via a particular medium (such as, for example, audio, video, text etc.). Instead, the access rights are normally allocated in accordance with particular predetermined rules. The allocation of access rights is also called floor control and the allocation rules are called floor policy, for example in an Internet-based conference system according to an Internet Conferencing Framework defined by the IETF (Internet Engineering Task Force).

In a large conference room, for example, a conference system is used which provides the users with a number of microphones and loudspeakers for voice communication. The microphones must be switched on for use by the respective speaker. A microphone which is switched on blocks all other microphones so that only one speaker can ever be active. As an exception, one further microphone (for example the microphone of the conference leader) can also be active at the same time. The right to speak is thus always issued to only one user and possibly the conference leader.

A comparable service also exists for mobile radio telephones (push-to-talk services (PTT), for example the “Direct Connect” service by Nextel in the USA or Push-to-Talk over Cellular (PoC) of the Open Mobile Alliance (OMA)). Similar to a walkie-talkie, the speaker usually presses a special key on the mobile radio telephone in order to convey messages. The transmission of messages of other users is blocked during this time. In a conference system according to a proposal of the IETF, access rights are controlled by means of the so-called Binary Floor Control Protocol (BFCP).

In a conventional push-to-talk conference system, access rights are requested and allocated by means of the so-called Real-Time Transport Control Protocol (RTCP). As an alternative, access rights can also be controlled by means of BFCP.

In a conference system according to a proposal by the IETF (Internet Engineering Task Force), an example of an Internet-based conference system, and in a current push-to-talk conference system (also called PTT conference system in the text which follows), telecommunication sessions are controlled, for example, by using the Session Initiation Protocol (SIP).

Conference systems according to the IETF and PTT conference systems usually have a centralized architecture. This means that the users of such conference systems do not communicate directly with one another but via a central telecommunication server (also called telecommunication conference session server in the text which follows). In a mobile conference system, the central telecommunication server is arranged in the non-mobile part of the telecommunication network as will still be explained in greater detail in the text which follows.

A communication session in a conference system is usually started by a communication session user inviting the other communication session users to the communication session.

A communication session can also be started conditionally. In this case, at least one condition for starting the communication session is linked with the communication session invitation (and thus with the setting-up of the communication session). The condition or the conditions can be sent to the central telecommunication server with the invitation to the conference session. The telecommunication server checks the condition(s) and only starts the requested conference session if the condition(s) has (have) been met.

The users of a communication session can be invited by an inviting user in that the inviting user sends the addresses of all other users to the central telecommunication server in the invitation. As an alternative, the other users can be invited in that the inviting user sends the address of a communication group (also called user group in the text which follows) to the telecommunication server with the invitation. The telecommunication server then enquires, for example from its responsible so-called group management server, which users belong to the communication group.

Communication groups can be hierarchically structured. This means that an invitation can contain group addresses and that groups, in turn, can contain addresses of other groups (also called user group addresses in the text which follows).

The addresses of members of communication groups defined in one's own telecommunication network can be requested by the communication conference server, for example from the group management server of its own telecommunication network. The addresses of members of groups defined in an external telecommunication network can be requested by the communication conference server from the communication conference server of the external communication network in that it sends an invitation with the group address and with an information element, which has the first communication conference server as central (controlling) communication conference server, to the external communication conference server. The external communication conference server recognizes from the information element that the group is not to be invited but that the addresses of the group members are requested.

According to the OMA standard, different group management servers are used in different telecommunication networks. In the group management server of a telecommunication network, the communication groups are stored which are defined by communication users of the respective telecommunication network. A communication server of a particular telecommunication network only ever has access to the group management server of this telecommunication network.

This leads to communication session rejections frequently not being able to take into consideration conditions which relate to hierarchical communication group members because the central communication server does not know the members of subgroups of the hierarchical group. This is the case, for example, if subgroups belong to external telecommunication networks or are administered by one more group management servers of external networks.

Furthermore, presence information of external telecommunication networks can frequently not be used since the external telecommunication network frequently does not allow access to the presence information.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of various embodiments. In the following description, various embodiments are described with reference to the following drawings, in which:

FIG. 1 shows a block diagram of a telecommunication conference system according to an illustrative embodiment;;

FIG. 2 shows a block diagram of a telecommunication conference system according to an illustrative embodiment in greater detail;

FIG. 3 shows a block diagram of a telecommunication conference system according to an illustrative embodiment in greater detail;

FIG. 4 shows a message flowchart in which the message flow for setting up a conference session according to an illustrative embodiment is shown;

FIG. 5 shows a message flowchart in which the message flow for setting up a conference session according to another illustrative embodiment is shown; and

FIG. 6 shows a flowchart in which a method according to another illustrative embodiment is shown.

### DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

In the context of the present description, the terms “connected” and “coupled” are used for describing both a direct connection and indirect connection and a direct or indirect coupling. In the figures, identical or similar elements are provided with identical reference symbols in as much as this is appropriate.

In the context of the present description, a circuit may be understood to be, for example, any type of hard-wired logic or programmable logic. A circuit may thus be, for example, a programmable processor (for example a programmable microprocessor, for example a complex instruction set controller (CISC) microprocessor or a reduced instruction set controller (RISC) microprocessor) which implements the respective functionality of the circuit (for example by means of a correspondingly arranged program code). Several circuits may be provided integrated in a common circuit or in separate circuits. Thus, it may be provided in one illustrative embodiment that the functionalities, for example of a conference server, are implemented in one or several microprocessors of the conference server.

According to various illustrative embodiments, a conditional setting-up of a communication session with a multiplicity of telecommunication session user terminals may be achieved, wherein at least one telecommunication session user terminal is identified by means of a group of user terminals.

In a method for the conditional setting-up of a telecommunication conference session (also called conference session in the text which follows) with a multiplicity of telecommunication conference session user terminals, wherein a group of user terminals having at least one telecommunication conference session user terminal (also called user terminal in the text which follows) may be identified by means of a telecommunication conference session user group identification (also called user group identification in the text which follows), an enquiry for determining a condition-related information item about the at least one telecommunication conference session user terminal of the telecommunication conference session user group identified by means of the telecommunication conference session user group identification (also called user group in the text which follows) may be conveyed from a first telecommunication conference session server to a second telecommunication conference session server (the telecommunication conference session servers will also be called conference servers in the text which follows). The condition-related information item is determined by means of the second telecommunication conference session server. A predefined telecommunication conference session set-up condition (also called conference set-up condition in the text which follows) may be checked by using the determined condition-related information item about the at least one telecommunication conference session user terminal and the telecommunication conference session with the multiplicity of telecommunication conference session user terminals may be set up (e.g. only) if the telecommunication conference session set-up condition is met.

In case the telecommunication conference session set-up condition is not met, the telecommunication conference session with the multiplicity of telecommunication conference session user terminals may not be set up in accordance with an embodiment.

In another method for the conditional setting-up of a telecommunication conference session with a multiplicity of telecommunication conference session user terminals, wherein a group of user terminals having at least one telecommunication conference session user terminal may be identified by means of a telecommunication conference session user group identification, a predefined telecommunication conference session set-up condition may be checked by involving two telecommunication conference session servers. A first telecommunication conference session server receives an enquiry for the conditional setting-up of a telecommunication conference session and a second telecommunication conference session server determines condition-related information for checking the predefined telecommunication conference session set-up condition.

In an embodiment, the telecommunication conference session may be a half-duplex telecommunication conference session, for example a push-to-talk telecommunication conference session, for example a push-to-talk over cellular telecommunication conference session.

In another embodiment, the telecommunication conference session may be an Internet-based telecommunication conference session, for example, an Internet-based half-duplex telecommunication conference session.

A half-duplex telecommunication conference may generally be understood to be any telecommunication conference in which an access right is in each case assigned to one user of the telecommunication conference, at the most, i.e. a maximum of one user of the telecommunication conference can send messages into the telecommunication conference; all other users of the telecommunication conference act in this case as receivers and thus do not have an access right themselves and cannot send any messages, for example any voice messages, into the telecommunication conference and thus to other users of the telecommunication conference.

An access right may generally be understood to be the right of conveying any types of communication data as users of a telecommunication conference to other users of the telecommunication conference. In a telecommunication conference, the data can be multimedia data, for example audio data, video data, static picture data, text data etc. If audio data are transmitted as part of the telecommunication conference, the access right is also called right to talk for the respective user in the text which follows.

In one illustrative embodiment, the communication session may be set up by using at least one telecommunication conference control message according to a telecommunication conference control protocol, wherein the telecommunication conference control protocol can be a protocol of the following protocols (but is not restricted to these examples): Session Initiation Protocol (SIP), Real Time Transport Control Protocol (RTCP), Binary Floor Control Protocol (BFCP).

As will still be explained in greater detail in the text which follows, the communication session, in one illustrative embodiment, may be set up by using at least one Session Initiation Protocol INVITE message and/or at least one Session Initiation Protocol SUBSCRIBE/NOTIFY message as telecommunication conference control message.

The first telecommunication conference session server and the second telecommunication conference session server may be arranged in different telecommunication networks.

Furthermore, the telecommunication conference session user group identification may identify a multiplicity of telecommunication conference session user terminals grouped to form the user group. The telecommunication conference session user group identification may have or be a user group address.

The group identified by means of the telecommunication conference session user group identification may have an additional telecommunication conference session user group identification which identifies at least one additional telecommunication conference session user terminal. In this embodiment, the telecommunication conference session user group identification may have or be a hierarchical user group address since the user group address can have group members who in turn represent a user group and are identified by means of a user group address.

In one embodiment, an enquiry for availability information of the at least one telecommunication conference session user terminal, which is identified by means of the telecommunication conference session user group identification, may be sent to a presence server which is arranged in a different telecommunication network from the first telecommunication conference session server.

Furthermore, the enquiry for availability information of the at least one telecommunication conference session user terminal, which may be identified by means of the telecommunication conference session user group identification, may have the telecommunication conference session user group identification.

In another embodiment, the first telecommunication conference session server may determine whether the telecommunication conference session user group identification identifies a group of at least one telecommunication conference session user terminal.

Furthermore, it can be provided in an embodiment that the first telecommunication conference session server determines whether the telecommunication conference session user group identification identifies a group of at least one telecommunication conference session user terminal by conveying a group enquiry message to the second telecommunication conference session server, which group enquiry message is used to enquire whether the telecommunication conference session user group identification identifies a group of at least one telecommunication conference session user terminal.

The telecommunication conference session user group identification may be a telecommunication conference session user group address, for example a SIP address which, for example, identifies the user group.

The telecommunication conference session user group address can have the same structural configuration as a telecommunication conference session user terminal address identifying a single telecommunication conference session user terminal (it may be, for example, a SIP address). In this case, it is not immediately clear to the first telecommunication conference session server that the telecommunication conference session user group address is an address by means of which a user group is identified and not only an address by means of which a single user terminal is identified.

The condition-related information item can have at least one of the following information items:

at least one telecommunication conference session user terminal address which identifies the at least one telecommunication conference session user terminal,

an information item about the number of available telecommunication conference session user terminals (for the conference),

an information item about a spatial location area of at least one telecommunication conference session user terminal,

an information item about the availability of at least one predefined telecommunication conference session user terminal.

The condition-related information item may be conveyed to the first telecommunication conference session server.

Furthermore, the result of the check of the telecommunication conference session set-up condition may be conveyed to the first telecommunication conference session server.

Furthermore, the first telecommunication conference session server may check the predefined telecommunication conference session set-up condition.

In another embodiment, it is provided that the condition-related information item is conveyed by the second telecommunication conference session server to a test circuit and that the test circuit checks the predefined telecommunication conference session set-up condition.

According to another illustrative embodiment, a telecommunication conference arrangement for the conditional setting-up of a telecommunication conference session with a multiplicity of telecommunication conference session user terminals is provided, wherein a group of user terminals having at least one telecommunication conference session user terminal may be identified by means of a telecommunication conference session user group identification. The telecommunication conference arrangement may have a first telecommunication conference session server which, in turn, has an enquiry-generating circuit configured to generate an enquiry for determining a condition-related information item about the at least one telecommunication conference session user terminal of the telecommunication conference session user group identified by means of the telecommunication conference session user group identification, and a transmitter configured to transmit the enquiry to a second telecommunication conference session server. Furthermore, the telecommunication conference arrangement may have a second telecommunication conference session server which, in turn, may have a receiver configured to receive the enquiry from the first telecommunication conference session server, and a determination circuit configured to determine the condition-related information item. Furthermore, in the telecommunication conference arrangement, a test circuit may be provided which is configured to check a predefined telecommunication conference session set-up condition by using the determined condition-related information item about the at least one telecommunication conference session user terminal. A telecommunication conference session set-up circuit, which may also be provided in the telecommunication conference arrangement, may be configured to set up the telecommunication conference session with the multiplicity of telecommunication conference session user terminals if the telecommunication conference session set-up condition is met.

The first telecommunication conference session server and the second telecommunication conference session server may be arranged for communication in accordance with a half-duplex telecommunication conference session, for example for communication according to a push-to-talk telecommunication conference session, for example for communication according to a push-to-talk over cellular telecommunication conference session.

In another embodiment, the first telecommunication conference session server and the second telecommunication conference session server may be arranged for communication according to an Internet-based telecommunication conference session, for example for communication according to an Internet-based IETF telecommunication conference session, for example for communication according to a telecommunication conference session according to the IETF Conferencing Framework.

The first telecommunication conference session server and the second telecommunication conference session server may be arranged for setting up the communication session by using at least one telecommunication conference control message according to a telecommunication conference control protocol, wherein the telecommunication conference control protocol may be a protocol of the following protocols (but is not restricted to these examples): Session Initiation Protocol (SIP), Real Time Transport Control Protocol (RTCP), Binary Floor Control Protocol (BFCP).

Furthermore, the first telecommunication conference session server and the second telecommunication conference session server may be configured to set up the communication session by using at least one Session Initiation Protocol INVITE message and/or at least one Session Initiation Protocol SUBSCRIBE/NOTIFY message as a telecommunication conference control message.

In an embodiment, the first telecommunication conference session server and the second telecommunication conference session server may be arranged in different telecommunication networks.

The telecommunication conference session user group identification may identify a multiplicity of telecommunication conference session user terminals grouped to form the user group.

Furthermore, it may be provided that the group identified by means of the telecommunication conference session user group identification has an additional telecommunication conference session user group identification which identifies at least one additional telecommunication conference session user terminal.

The first telecommunication conference session server may also have an enquiry-message-generating circuit, wherein the enquiry message may have an enquiry for availability information of the at least one telecommunication conference session user terminal which is identified by means of the telecommunication conference session user group identification. The transmitter of the first telecommunication conference session server can be arranged for transmitting the enquiry message to a presence server which is arranged in a different telecommunication network from the first telecommunication conference session server.

In various illustrative embodiments, the presence server may be configured to determine and provide availability information for one or more user terminals. In the context of the present description, availability information may be understood to be, for example, an information item about whether a user terminal is currently available, for example for a conference session or generally for setting up a communication link. For example, the availability information may contain the so-called online status and/or the position of the respective user terminal. In various illustrative embodiments, the availability information may also contain, for example, information additionally provided by the presence server such as, for example, information such as “mood” (the mood of the user), “notes” (additional notes or comments with respect to the user terminal), etc.

In another embodiment of the telecommunication conference arrangement, a presence server may be provided which may be arranged in a different telecommunication network from the first telecommunication conference session server.

The enquiry message for availability information of the at least one telecommunication conference session user terminal, which is identified by means of the telecommunication conference session user group identification, may have the telecommunication conference session user group identification.

Furthermore, the first telecommunication conference session server may have a group determination circuit which may be arranged for determining whether the telecommunication conference session user group identification identifies a group of at least one telecommunication conference session user terminal.

The group determination circuit may be arranged in such a manner that it determines whether the telecommunication conference session user group identification identifies a group of at least one telecommunication conference session user terminal by conveying a group enquiry message to the second telecommunication conference session server, which group enquiry message may be used to enquire whether the telecommunication conference session user group identification identifies a group of at least one telecommunication conference session user terminal.

The telecommunication conference session user group identification may be a telecommunication conference session user group address.

In one embodiment, the telecommunication conference session user group address may have the same structural configuration as a telecommunication conference session user terminal address identifying a single telecommunication conference session user terminal.

The condition-related information item may have at least one of the following information items:

at least one telecommunication conference session user terminal address which identifies the at least one telecommunication conference session user terminal,

an information item about the number of available telecommunication conference session user terminals,

an information item about a spatial location area of at least one telecommunication conference session user terminal,

an information item about the availability of at least one predefined telecommunication conference session user terminal.

The first telecommunication conference session server may also have a receiver configured to receive the condition-related information item.

The first telecommunication conference session server may also have a receiver configured to receive the result of the check of the telecommunication conference session set-up condition.

Furthermore, a test circuit may be provided which is configured to check the predefined telecommunication conference session set-up condition.

The first telecommunication conference session server may have the test circuit. In other words, the test circuit may be integrated in the first telecommunication conference session server.

In yet another illustrative embodiment, a telecommunication conference session server may be provided for the conditional setting-up of a telecommunication conference session with a multiplicity of telecommunication conference session user terminals, wherein a group of user terminals having at least one telecommunication conference session user terminal is identified by means of a telecommunication conference session user group identification. The telecommunication conference session server may have an enquiry-generating circuit configured to generate an enquiry for determining a condition-related information item about the at least one telecommunication conference session user terminal of the telecommunication conference session user group identified by means of the telecommunication conference session user group identification, and a transmitter configured to transmit the enquiry to another telecommunication conference session server.

The telecommunication conference session server may be arranged for communication in accordance with a half-duplex telecommunication conference session, for example for communication according to a push-to-talk telecommunication conference session, for example for communication according to a push-to-talk over cellular telecommunication conference session.

Furthermore, the telecommunication conference session server may be arranged for communication according to an Internet-based telecommunication conference session, for example an Internet-based half-duplex telecommunication conference session, for example an Internet-based IETF telecommunication conference session.

Furthermore, the telecommunication conference session server may be configured to set up the communication session by using at least one telecommunication conference control message according to a telecommunication conference control protocol, wherein the telecommunication conference control protocol may be a protocol of the following protocols (but is not restricted to these examples): Session Initiation Protocol (SIP), Real Time Transport Control Protocol (RTCP), Binary Floor Control Protocol (BFCP).

In another illustrative embodiment, the telecommunication conference session server may be configured to set up the communication session by using at least one Session Initiation Protocol INVITE message and/or at least one Session Initiation Protocol SUBSCRIBE/NOTIFY message as telecommunication conference control message.

The telecommunication conference session user group identification may identify a multiplicity of telecommunication conference session user terminals grouped to form the user group.

Furthermore, the group identified by means of the telecommunication conference session user group identification may have an additional telecommunication conference session user group identification which identifies at least one additional telecommunication conference session user terminal.

According to one embodiment, the telecommunication conference session server may have an enquiry-message-generating circuit, wherein the enquiry message may have an enquiry for availability information of the at least one telecommunication conference session user terminal which is identified by means of the telecommunication conference session user group identification. The transmitter may be configured to transmit the enquiry message to a presence server which is arranged in a different telecommunication network from the first telecommunication conference session server.

The enquiry message for availability information of the at least one telecommunication conference session user terminal, which is identified by means of the telecommunication conference session user group identification, may have the telecommunication conference session user group identification.

Furthermore, the telecommunication conference session server may have a group determination circuit which is configured to determine whether the telecommunication conference session user group identification identifies a group of at least one telecommunication conference session user terminal.

The group determination circuit may be configured in such a manner that it determines whether the telecommunication conference session user group identification identifies a group of at least one telecommunication conference session user terminal by conveying a group enquiry message to the second telecommunication conference session server, which group enquiry message may be used to enquire whether the telecommunication conference session user group identification identifies a group of at least one telecommunication conference session user terminal.

The telecommunication conference session user group identification may have or be a telecommunication conference session user group address.

The telecommunication conference session user group address may have the same structural configuration as a telecommunication conference session user terminal address identifying a single telecommunication conference session user terminal.

In one embodiment, the condition-related information item may have at least one of the following information items:

at least one telecommunication conference session user terminal address which identifies the at least one telecommunication conference session user terminal,

an information item about the number of available telecommunication conference session user terminals,

an information item about a spatial location area of at least one telecommunication conference session user terminal,

an information item about the availability of at least one predefined telecommunication conference session user terminal.

According to an illustrative embodiment, the telecommunication conference session server may have a receiver configured to receivieng the condition-related information item.

According to an illustrative embodiment, the telecommunication conference session server may have a receiver configured to receive the result of the check of the telecommunication conference session set-up condition.

Furthermore, the telecommunication conference session server may have a test circuit which is configured to check the predefined telecommunication conference session set-up condition.

In another illustrative embodiment, a method for generating an enquiry for the conditional setting-up of a telecommunication conference session with a multiplicity of telecommunication conference session user terminals is provided, wherein a group of user terminals having at least one telecommunication conference session user terminal is identified by means of a telecommunication conference session user group identification. An enquiry for determining a condition-related information item about the at least one telecommunication conference session user terminal of the telecommunication conference session user group identified by means of the telecommunication conference session user group identification may be generated by a telecommunication conference session server.

In yet another illustrative embodiment, a telecommunication conference session server may be provided for the conditional setting-up of a telecommunication conference session with a multiplicity of telecommunication conference session user terminals, wherein a group of user terminals having at least one telecommunication conference session user terminal is identified by means of a telecommunication conference session user group identification. The telecommunication conference session server may have a receiver configured to receive an enquiry for determining a condition-related information item about the at least one telecommunication conference session user terminal of the telecommunication conference session user group identified by means of the telecommunication conference session user group identification from another telecommunication conference session server, and a determination circuit configured to determine the condition-related information item.

The telecommunication conference session server may be arranged for communication in accordance with a half-duplex telecommunication conference session, for example for communication according to a push-to-talk telecommunication conference session, for example for communication according to a push-to-talk over cellular telecommunication conference session.

Furthermore, the telecommunication conference session server may be arranged for communication according to an Internet-based telecommunication conference session, for example an Internet-based half-duplex telecommunication conference session, for example an Internet-based IETF telecommunication conference session.

The telecommunication conference session server may also be arranged for setting up the communication session by using at least one telecommunication conference control message according to a telecommunication conference control protocol, wherein the telecommunication conference control protocol may be a protocol of the following protocols (but is not restricted to these examples): Session Initiation Protocol (SIP), Real Time Transport Control Protocol (RTCP), Binary Floor Control Protocol (BFCP).

In another illustrative embodiment, the telecommunication conference session server may be configured to set up the communication session by using at least one Session Initiation Protocol INVITE message and/or at least one Session Initiation Protocol SUBSCRIBE/NOTIFY message as telecommunication conference control message.

The telecommunication conference session user group identification may identify a multiplicity of telecommunication conference session user terminals grouped to form the user group.

Furthermore, the group identified by means of the telecommunication conference session user group identification may have an additional telecommunication conference session user group identification which identifies at least one additional telecommunication conference session user terminal.

In one illustrative embodiment, the telecommunication conference session user group identification may be a telecommunication conference session user group address.

The telecommunication conference session user group address may have the same structural configuration as a telecommunication conference session user terminal address identifying a single telecommunication conference session user terminal.

In one embodiment, the condition-related information item may have at least one of the following information items:

at least one telecommunication conference session user terminal address which identifies the at least one telecommunication conference session user terminal,

an information item about the number of available telecommunication conference session user terminals,

an information item about a spatial location area of at least one telecommunication conference session user terminal,

an information item about the availability of at least one predefined telecommunication conference session user terminal.

Furthermore, the telecommunication conference session server may have a transmitter configured to transmit the condition-related information item to a test circuit which may be configured to check the predefined telecommunication conference session set-up condition.

In another illustrative embodiment, a method may be provided for determining a condition-related information item for the conditional setting-up of a telecommunication conference session with a multiplicity of telecommunication conference session user terminals, wherein a group of user terminals having at least one telecommunication conference session user terminal is identified by means of a telecommunication conference session user group identification, wherein an enquiry for determining a condition-related information item about the at least one telecommunication conference session user terminal of the telecommunication conference session user group identified by means of the telecommunication conference session user group identification may be received from another telecommunication conference session server and wherein the condition-related information item may be determined by a telecommunication conference session server receiving the enquiry.

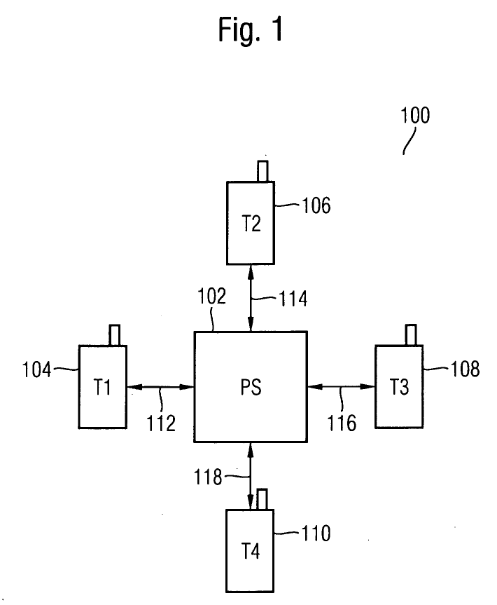

FIG. 1 shows a simplified representation of a telecommunication conference system 100 according to an illustrative embodiment.

The telecommunication conference system 100 may be configured in accordance with push-to-talk over cellular (PoC) according to the standard of the Open Mobile Alliance (OMA), the individual components additionally being arranged in such a manner that they can carry out the methods and communication protocols described in the text which follows.

In this context, it should be noted that the architecture of the telecommunication conference system 100 described in FIG. 1 may be identical for all illustrative embodiments described in the text which follows.

The telecommunication conference system 100 may have a central push-to-talk over cellular server PS 102 (PTT server) as conference server, and a multiplicity of mobile radio communication terminals, for example mobile radio telephones 104, 106, 108, 110, the mobile radio communication terminals 104, 106, 108, 110 in each case containing a push-to-talk over cellular client unit which is arranged for communication according to the Push-to-Talk over cellular communication standard. The mobile radio communication terminals 104, 106, 108, 110 may be coupled to the PTT server 102 by means of a respective radio communication link 112, 114, 116, 118 via a respective air interface. The users T1, T2, T3, T4, and thus the users of the mobile radio communication terminals 104, 106, 108, 110 thus do not communicate directly with one another but by means of the central PTT server 102.

According to this illustrative embodiment of the invention, four users T1, T2, T3, T4, and thus four mobile radio communication terminals 104, 106, 108, 110, are shown in a simplifying manner, although an arbitrary number of users and mobile radio communication terminals may be provided. The users T1, T2, T3, T4 communicate by means of audio, i.e. by means of speech, a respective user in each case being assigned exclusively an access right, a right to talk according to the present illustrative embodiment, by the PTT server 102 in accordance with the half-duplex method.

The allocation of the right to talk, the allocation of the access right generally and thus the access right control, is effected by the PTT server 102 by means of messages according to the Real-Time Transport Control Protocol (RTCP) communication protocol. Requested access rights are stored in a queue which is implemented in a memory of the PTT server 102. With the assignment of an access right, each user is assigned a time slot in which he can transmit voice data to the other users of the telecommunication conference without the other users being able to interrupt him.

During this time, the other users cannot introduce any data into the telecommunication conference, i.e. they do not obtain an access right.

It should be pointed out that, in alternative illustrative embodiments, the telecommunication conference system 100 may be arranged according to the IETF Conferencing Framework according to a standard of the Internet Engineering Task Force (IETF).

Furthermore, the mobile radio communication terminals 104, 106, 108, 110 may be arranged as cordless communication terminals or also as wire-connected communication terminals. The communication terminals may be integrated in a computer, for example in a personal computer, in a work station, in a personal digital assistant (PDA), a laptop, a notebook, generally any system provided with a processor and which is suitable for participating in a telecommunication conference.

In one illustrative embodiment, the central conference server in the telecommunication conference system 100 may have a controlling function and generally several participating functions communicating with the controlling function. To each user T1, T2, T3, T4, and thus to each mobile radio communication terminal 104, 106, 108, 110, one participating function is allocated. According to one illustrative embodiment, the controlling function may have functionalities which are allocated to the respective PTT session (generally the respective conference session). A participating function contains functionalities which are allocated to the user belonging to the participating function. A participating function is illustratively a part of the associated user communication terminal 104, 106, 108, 110, this part being arranged in the non-mobile communication network.

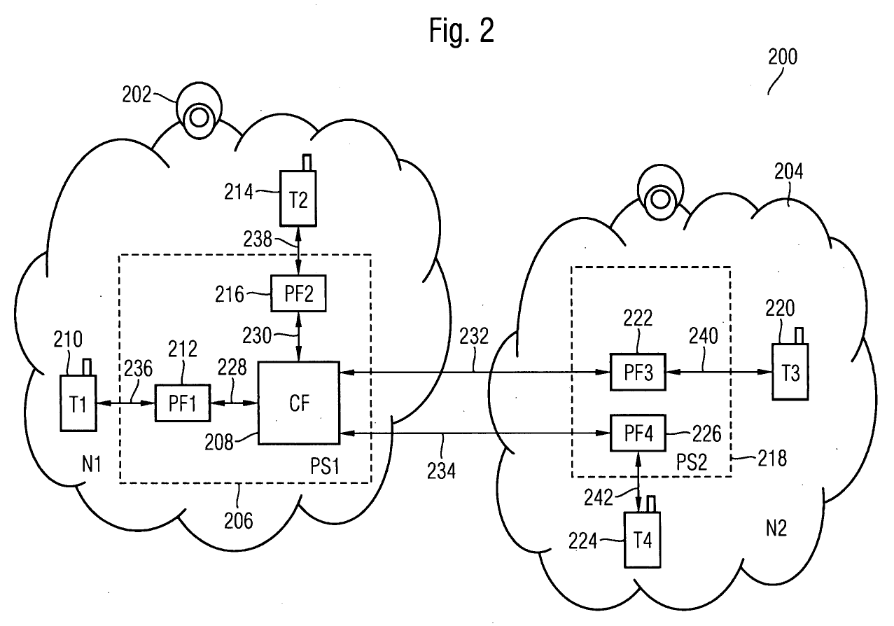

The participating function and the controlling function of users of a PTT conference session may be arranged in different conference servers. This is the case, e.g., if the PTT conference session was generated in the communication network of a communication network operator other than the operator of the user's own communication network. The participating function of the user may then be located in a PTT conference server of the user's own communication network operator. The controlling function of the PTT conference session, in contrast, may be arranged in a PTT conference server of the other communication network operator. The user, and thus his user communication terminal, communicates with the PTT communication session by means of a communication link between the PTT conference server of his own communication network and the PTT conference server of the other communication network. FIG. 2 shows this architecture.

FIG. 2 shows a block diagram of a telecommunication conference system 200 according to an illustrative embodiment in greater detail.

The telecommunication conference system 200 which may also be arranged according to a PTT standard, for example according to PoC as described above in conjunction with FIG. 1, has in this example a first communication network N1 202 of a first communication network operator and a second communication network N2 204 of a second communication network operator.

As an alternative, the telecommunication conference system 200 is, for example, an Internet-based conference system (for example configured according to the IETF Conferencing Framework).

In the example shown in FIG. 2, it is assumed that the first communication network N1 202 has a first conference server 206 which, in turn, for example, has implemented a controlling function (CF) 208 of a telecommunication conference and a participating function (PF) for each communication terminal participating in the telecommunication conference session administered by the controlling function 208, which communication terminal is located in the coverage area of the first communication network N1 202. In this example, it is assumed that a first mobile radio communication terminal (generally a first user terminal) 210 of a first user T1 and a second mobile radio communication terminal (generally a second user terminal) 214 of a second user T2 are located in the first communication network N1 202. The first conference server 206 thus provides a first participating function (PF1) 212 (for the first user terminal 210) and a second participating function (PF2) 216 (for the second user terminal 214).

Furthermore, it is assumed in the example shown in FIG. 2 that the second communication network N2 204 has a second conference server 218 which, in turn, has implemented a participating function for each communication terminal participating in the telecommunication conference session administered by the controlling function 208 of the first communication network N1 202, which communication terminal is located in the coverage area of the second communication network N2 204. It is assumed in this example that a third mobile radio communication terminal (generally a third user terminal) 220 of a third user T3 and a fourth mobile radio communication terminal (generally a fourth user terminal) 224 of a fourth user T4 are located in the second communication network N2 204. The second conference server 218 thus provides a third participating function (PF3) 222 (for the third user terminal 220) and a fourth participating function (PF4) 226 (for the fourth user terminal 224).

Furthermore, the controlling function 208 of the first communication network N1 202 provides as part of the conference session a respective bidirectional communication link 228, 230, 232, 234 at the controlling function end with a respective participating function 212, 216, 222, 226 and the respective participating function 212, 216, 222, 226 provides a bidirectional communication link 236, 238, 240, 242 at the terminal end with the user terminal 210, 214, 220, 224 allocated to the respective participating function 212, 216, 222, 226.

In one illustrative embodiment, a communication conference session may be started in the conference system 100, 200 in that a conference session user invites the other conference session users to the conference session by means of his user terminal.

In one illustrative embodiment of the invention, a conference session may be started conditionally, in other words the conference session is only started if one or more predefined conditions (also called conference session set-up condition(s) in the text which follows) are met. In this connection, for example, one or more conditions for starting the conference session are linked to the conference session invitation. The one or more conditions may be sent out with the invitation to the central conference server (for example the first conference server 206). For example, the conference server checks the one or more conditions and starts the requested conference session only when the one or more conditions is or are met.

As an alternative, the condition(s) may also be checked by the communication terminal of the inviting user. The communication terminal in this case sends out a session invitation to the central conference server (for example the first conference server 206) only when the condition(s) is or are met.

It may also be provided to automatically check the conditions repeatedly (by the communication terminal or by the central conference server) and to start the conference session depending on the conditions being met or to break it off (for example when a conference session is already set up).

The following may be provided, for example, as conditions for the start (in other words setting-up) of a communication conference session:

a predefined minimum number of available conference session users or their user terminals;

a predefined particular spatial location area of the conference session users or their user terminals;

an availability of certain (required) predefined conference session users or their user terminals.

The users of a communication conference session may be invited by an inviting user in that the inviting user sends to the central conference server in the invitation the addresses of all other users or their user terminals which he wants to invite to the conference session. As an alternative, the other users may be invited in that the inviting user sends the address of a communication group (also called user group in the text which follows) to the conference server with the invitation. The conference server then enquires, for example at his responsible so-called group management server, which users belong to the communication group specified in each case.

Instead of sending the conditions for the start of a conference session to the conference server with the invitation, the conditions may also be specified in the group management server together with a communication group defined there. When a communication user invites such a communication group, the central conference server requests the conditions together with the addresses of the group members of the communication group from the group management server.

In one illustrative embodiment, the communication groups may be structured hierarchically. This means that an invitation may contain communication group addresses and that communication groups, in turn, may contain addresses of other communication groups.

The communication conference server may enquire the addresses of members of communication groups defined in its own network from the group management server of its own communication network (for example the first communication network N1 202).

The communication conference server (e.g. the first conference server 206) may enquire the addresses of members of communication groups defined in another communication network (for example the second communication network N2 204) from the communication conference server of the other communication network (e.g. the second conference server 218) in that it sends an invitation with the group address and with an information element, which identifies the first conference server (e.g. 206) as central (controlling) conference server, to the other communication conference server (e.g. the conference server 218). The other conference server (e.g. 218) recognizes from the information element that the communication group is not to be invited but that the addresses of the group members of the communication group are requested by means of the invitation.

According to the OMA standard, different group management servers may be used in different communication networks. In the group management server of a communication network, the communication groups are deposited, or in other words stored, which, for example, are defined by a communication user of the respective communication network. In this example, a communication conference server of a particular communication network always may have access only to the group management server of this communication network as a result of which the first conference server itself, for example, is not capable of dissolving the communication groups which are defined in the second communication network and determining the user terminal addresses from the user group which are contained in the communication group identified by means of the user group address.

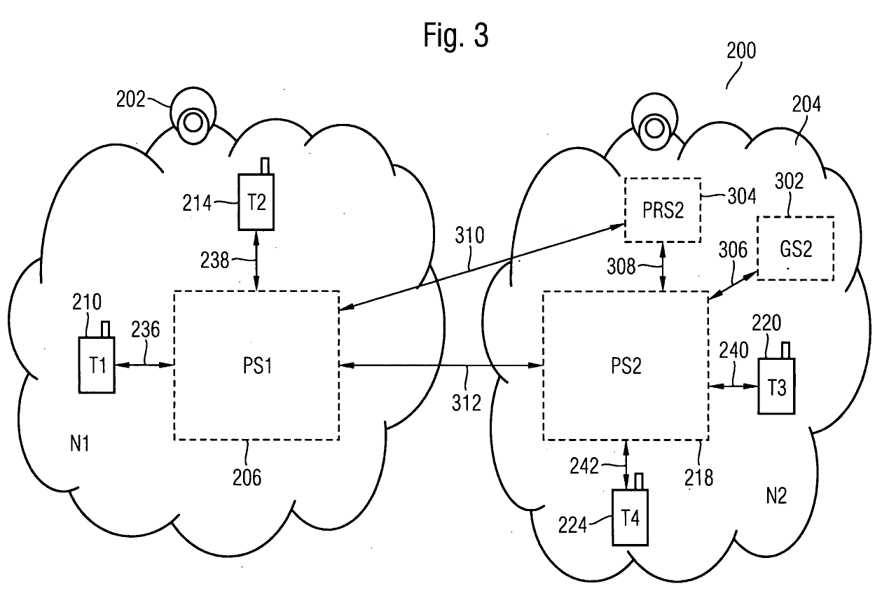

In the text which follows, the general validity of a PoC communication system 200 is considered without restriction in order to describe illustrative embodiments in greater detail, referring to FIG. 3. In other words, a communication by PoC service is considered.

In this example, it is assumed that a group management server GS2 302 (which manages the user groups defined in the second communication network N2 204 and can determine for a user group address the user terminals contained in this group and/or their user terminal addresses) and a presence server PRS2 304, which is arranged for determining the presence of a user terminal identified by means of a user terminal address, are provided in the second communication network N2 204.

In the illustrative embodiment shown in FIG. 3, the group management server 302 is coupled to the second conference server 218 by means of a first bidirectional communication link 306. Furthermore, the presence server 304 may be coupled to the second conference server 218 by means of a second bidirectional communication link 308 and to the first conference server 206 by means of a third bidirectional communication link 310. Furthermore, the first conference server 206 and the second conference server 218 are coupled to one another by means of a fourth bidirectional communication link 312.

It is assumed in this example that the first user (PoC user) T1 wishes to communicate with the second user (PoC user) T2 and with the users of a predefined and stored communication group (e.g. PoC group) G1. The second user terminal 214 of the second user T2 belongs to the first communication network N1 202 to which the first user terminal 210 of the first user T1 also belongs. In this example, the communication group G1 may be defined in the group management server 302 of the second communication network N2 204. Thus, respective information about the users contained in the communication group G1 may be stored (for example in a table or in another suitable form) in the group management server 302, for example for the communication group G1 (which for example, is identified by means of a user group address (for example, a SIP address)) (for example, the respective user terminal address of the users of the communication group G1 is stored).

Furthermore, it is assumed in this example that the conference session should only be started when at least two (alternatively an arbitrary predefinable number of) members of the communication group G1 are available for the conference session. Information about the availability of the members of the communication group G1 can be enquired from the presence server PRS2 304 of the second communication network N2 204 by means of the second bidirectional communication link 308 from the second conference server 218 or by means of the third bidirectional communication link 310 from the first conference server 206.

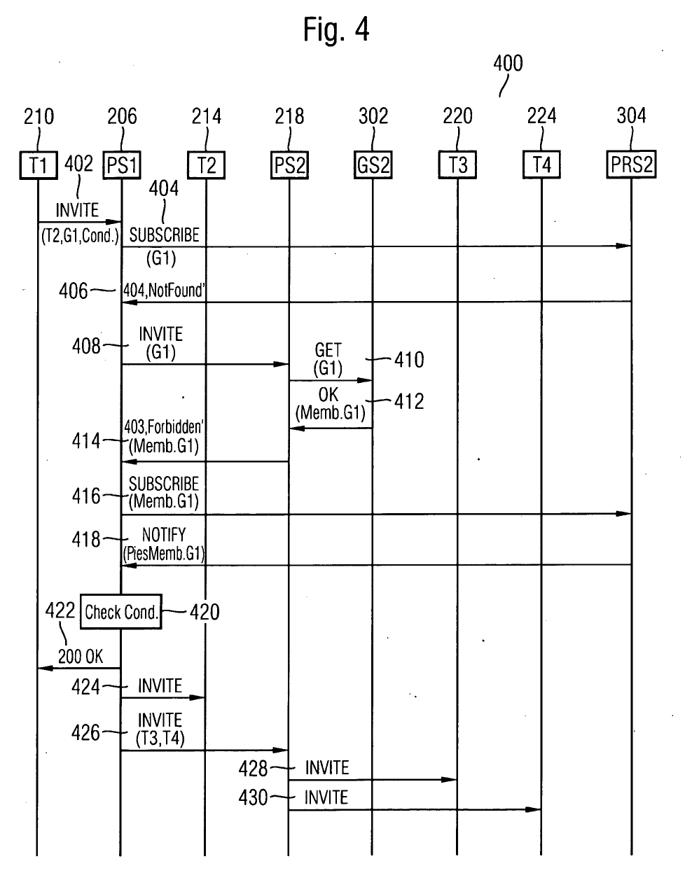

To start the conference session, the first user terminal 210 of the first user T1 generates and sends out a conference session invitation message which contains the addresses of the second user terminal 214 of the second user T2 (in the present case a user terminal address) and of the communication group G1 (in the present case a user group address) to the first conference server (e.g. first PoC server) PS1 206 of its communication network (e.g. the first communication network N1 202). The conference session invitation message also has a conference set-up condition, namely, for example, that the conference session is only started when at least two members of the communication group G1 are available. The conference session invitation message is designated by reference symbol 402 in a message flowchart 400 in FIG. 4. In this example, the conference session invitation message 402 is an SIP INVITE message, as will still be explained in greater detail in the text which follows.

After the first conference server PS1 206 has received the conference session invitation message 402 it checks the received addresses, i.e. the user terminal address of the second user terminal 214 of the second user T2 and the user group address of the communication group G1 and finds that the communication group G1 is an address which belongs to the other communication network, i.e. for example to the second communication network N2 204. It should be noted that, although the first conference server PS 206 in this illustrative embodiment recognizes that the user group address of the communication group G1 is an address of the other communication network, it cannot distinguish whether this is a user terminal address or a user group address since both are present in the same address format.

The first conference server PS1 206 now requests from the presence server PRS2 304 of the second communication network N2 204 availability information about the communication group G1, for example by means of an availability information request message 404 (for example in the form of a SIP SUBSCRIBE message) which is generated and conveyed to the presence server PRS2 304 by the first conference server PS1 206. The presence server PRS2 304 does not know the address of the communication group G1 since the presence server PRS2 304 only manages presence information of individual communication users, in other words only of user terminal addresses, not of user group addresses. The presence server PRS2 304 therefore informs the first conference server PS1 206 that the address of the communication group G1 is unknown to it. This is done, for example, by the presence server PRS2 304 generating a Not-Found message 406 and conveying it to the first conference server PS1 206. According to one illustrative embodiment, the Not-Found message 406 is an SIP 404 message with the information “Not Found” (SIP-404 “Not Found”).

After receiving the Not-Found message 406, the first conference server PS1 206 recognizes that the address of the communication group G1 is in fact a user group address and now requests the user terminal addresses of the members of the communication group G1 from the second conference server PS2 218 in the second communication network N2 204. According to one illustrative embodiment, this is done by the first conference server PS1 206 generating a group itemization request message (for example in the form of an SIP INVITE message) 408 and conveying it to the second conference server PS2 218.

In one illustrative embodiment of the invention, the request of the addresses is made by the first conference server PS1 206 by means of an SIP INVITE message as group itemization request message 408. The SIP INVITE message 408 contains the address of the communication group G1 as addressee. In addition, the SIP INVITE message 408 contains the feature tag ‘isfocus’. The feature tag ‘isfocus’ informs the receiving conference server, i.e., for example, the second conference server PS2 218, that the second conference server PS2 218 should not be the central conference server for the conference session in this case and should invite the members of the communication group G1 but that the addresses of the communication group G1 should be reported back to the sender of the SIP INVITE message 408, i.e. for example to the first conference server PS1 206.

In the following pseudo code representation, the general structure of the SIP INVITE message 408 according to an illustrative embodiment of the invention is described:

INVITE sip:G1.network2.net SIP/2.0
Max-Forwards: 70
From: sip:T@network1.net;tag=72648
To: sip:G1.network2.net
Contact:
<sip:Session1@PTTServer1.network1.net>;isfocus
Call-ID: asd88asd77a@1.2.3.4
CSeq: 1 INVITE
Content-Type: text/plain
Content-Length: 0

After receiving the group itemization request message 408, the second conference server PS2 218 requests the addresses (in the present case the user terminal addresses) of the group members of the requested communication group G1 from its responsible group management server 302 and then answers the first conference server PS1 206 with the addresses found which are now the itemized user terminal addresses of the user terminals of the communication group G1. In one illustrative embodiment, the second conference server PS2 218 requests the addresses of the group members of the requested communication group G1 from its responsible group management server 302 by generating a user terminal address request message 410 (with the user group address of the communication group G1 as request parameter), for example in the form of an XCAP GET message, and conveying it to the group management server 302 which, following the reception of the user terminal address request message 410, determines the user terminal addresses allocated to the communication group G1 and conveys these in a user terminal address response message 412 generated by it (for example in the form of an XCAP OK message which contains the user terminal addresses found for the members of the communication group G1) to the second conference server PS2 218.

After the second conference server PS2 218 has received the user terminal address response message 412 and thus determined the desired user terminal addresses of the members of the communication group G1, the second conference server PS2 218 conveys the user terminal addresses of the members of the communication group G1 to the first conference server PS1 206. According to one illustrative embodiment, this is done by the second conference server PS2 218 generating a group itemization response message 414 and conveying it to the first conference server PS1 206. The group itemization response message 414 contains the desired user terminal addresses of the members of the communication group G1. The group itemization response message 414 can be an SIP 403 ‘forbidden’ message 414 with the reported addresses of the members of G1.

In the following pseudo code representation, the general structure of the SIP 403 ‘forbidden’ message 414 according to one illustrative embodiment of the invention is described:

SIP/2.0 403 Forbidden
From: sip:T1@network1.net;tag=72648
To: sip:G1.network2.net
Call-ID: asd88asd77a@1.2.3.4
CSeq: 1 INVITE
Content-Type: text/plain
Content-Length: 39
sip:T3@network2.net
sip:T4@network2.net

In this example, the addresses “sip:T3@network2.net” and “sip:T4@network2.net” are the user terminal addresses of the members of the communication group G1.

After the first conference server PS1 206 has received the group itemization response message 414 and has thus determined the user terminal addresses of all desired users of the conference, the first conference server PS1 206 now requests availability information about the reported members of communication group G1 from the presence server PRS2 304 and checks which of the user terminal addresses obtained are available for communication. If at least two user terminal addresses are available (this is checked in 420), generally when the at least one predefined conference set-up condition is met (in the present example therefore the conference set-up condition: at least two user terminals of the communication group must be available for the conference), the first conference server PS1 206 sends out invitations (for example in the form of server invitation messages) to the second user terminal 214 of the second user T2 and to the available user terminal addresses of communication group G1. In addition, the first conference server PS1 206 notifies the first user terminal 210 of the first user T1 that there is an invitation to the conference session.

In one illustrative embodiment, the first conference server PS1 206 requests the availability information about the reported members of the communication group G1 from the presence server PRS2 by generating a further availability information request message 416 (for example in the form of an SIP SUBSCRIBE message), the further availability information request message 416 now containing the user terminal addresses of the desired user terminals and no longer a user group address, and conveying it to the presence server PRS2 304. The presence server PRS2 304 is now able to determine the desired availability information with respect to the specified user terminal addresses. The presence server PRS2 304 determines the desired availability information after receiving the further availability information request message 416.

After the presence server PRS2 304 has determined the requested availability information, it generates a further availability information request message 418 (for example in the form of an SIP NOTIFY message) which contains the requested availability information, and conveys it to the first conference server PS1 206.

The server invitation message 424 conveyed to the second user terminal 214 of the second user T2 is an SIP INVITE message 424 according to one illustrative embodiment. The available user terminals located in the second communication network N2 204 are invited by the first conference server PS1 206 generating one common or two individual SIP INVITE message(s) 426 and conveying these to the second conference server PS2 218. Following the reception of the common SIP INVITE message 426, the second conference server PS2 218 generates for each user terminal to be invited (e.g. 220, 224) in the second communication network N2 204 a respective SIP INVITE message 428 and 430 and conveys these to the respective user terminals to be invited (e.g. 220, 224).

In addition, the first conference server PS1 206 notifies the first user terminal 210 of the first user T1 which was invited to the conference session, by means of a conference set-up acknowledgement message 422 (for example in the form of an SIP 200 OK message 422), which is generated by the first conference server PS1 206 and is conveyed to the first user terminal 210 (to be invited) of the first user T1.

The conference session can now be established between all user terminals which accept the invitation to the conference session.

However, if it is found in the test step described above (in 420) that fewer than two of the received user terminal addresses of the communication group G1 are available (generally, if it is found that the at least one conference set-up condition is not met), the first conference server PS1 206 does not invite any communication users to a conference session. In addition, the first conference server PS1 206 reports in this case to the first user terminal 210 and thus the first user T1 that there is no invitation to the conference session since the condition(s) for it was (were) not met.

If the condition(s) was (were) not met at the time of the invitation, the first communication server PS1 206, according to one illustrative embodiment, optionally checks the condition(s) again later. If the condition(s) is or are met, the first communication server PS1 206 invites the users T1, T2 and the members of the communication group G1 to a conference session.

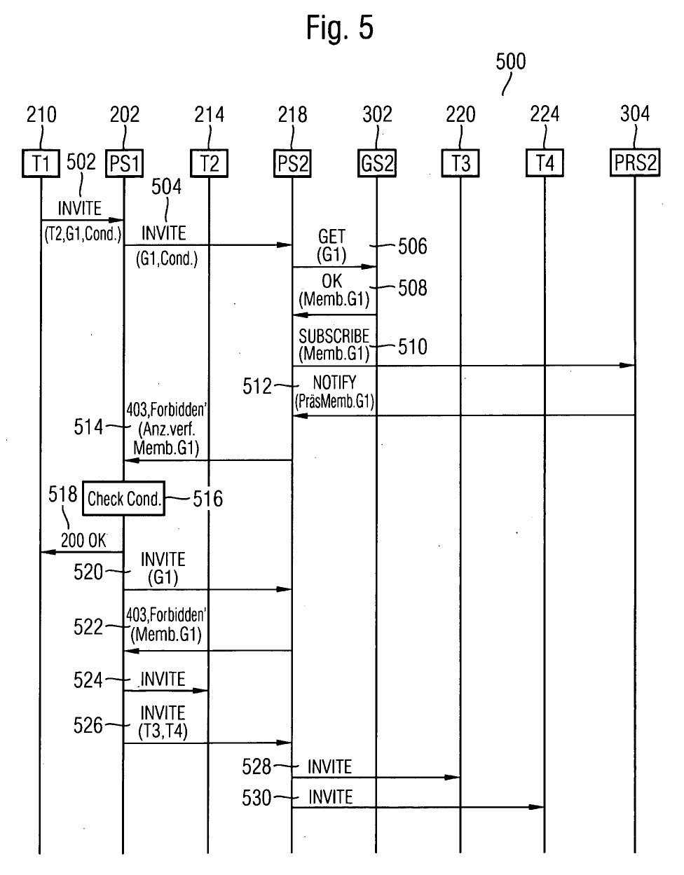

FIG. 5 shows a message flowchart 500 in which the message flow for setting up a conference session according to another illustrative embodiment is shown. However, in this example, too, the architecture shown in FIG. 3 is used as a basis.

It is assumed in this example that the first user (PoC user) T1 wishes to communicate with the second user (PoC user) T2 and with the users of a predefined and stored communication group (e.g. PoC group) G1. The second user terminal 214 of the second user T2 belongs to the first communication network N1 202 to which the first user terminal 210 of the first user T1 also belongs. In this example, the communication group G1 is defined in the group management server 302 of the second communication network N2 204. Thus, respective information about the users contained in communication group G1 is stored (for example in a table or in another suitable form) for example for the communication group G1 (which is identified, for example, by means of a user group address (for example an SIP address)) in the group management server 302 (for example, the respective user terminal address of the users of communication group G1 is stored).

Furthermore, it is assumed in this example that the conference session should only be started when at least two (alternatively an arbitrary predefinable number of) members of the communication group G1 are available for the communication session. Information about the availability of the members of the communication group G1 can be enquired from the presence server PRS2 304 of the second communication network N2 204 by means of the second bidirectional communication link 308 from the second conference server 218 or, respectively, by means of the third bidirectional communication link 310 from the first conference server 206.

To start the conference session, the first user terminal 210 of the first user T1 generates and sends out a conference session invitation message which contains the addresses of the second user terminal 214 of the second user T2 (in the present case a user terminal address) and of the communication group G1 (in the present case a user group address) to the first conference server (e.g. first PoC server) PS1 206 of its communication network (e.g. of the first communication network N1 202). The conference session invitation message also has a conference set-up condition, namely, for example, that the conference session is started only when at least two members of the communication group G1 are available. The conference session invitation message is designated by the reference symbol 502 in the message flowchart 500 in FIG. 5. In this example, the conference session invitation message 502 is an SIP INVITE message, as will still be explained in greater detail in the text which follows.

After the first conference server PS1 206 has received the conference session invitation message 502, it checks the received addresses, i.e. the user terminal address of the second user terminal 214 of the second user T2 and the user group address of communication group G1, and finds that the communication group G1 is an address which belongs to the other communication network, i.e. to the second communication network N2 204, for example.

According to the present example, the first conference server PS1 206 now requests the second conference server PS2 218 of the second communication network N2 204 to check the availability of the members of the communication group G1. In one illustrative embodiment this is done by the first conference server PS1 206 generating an availability information request message 504 (for example in the form of an SIP INVITE message 504, which contains the user group address of the communication group G1) and conveying it to the second conference server PS2 218. Furthermore, the availability information request message 504 can contain information about whether the first conference server PS1 206 wishes to have the user terminal addresses conveyed to it or, for example, only the number of available user terminal addresses of the communication group G1. In an alternative illustrative embodiment, it can be provided that the second conference server PS2 218 checks the at least one conference set-up condition and only conveys the test result to the first conference server PS1 206 (in this case the availability information request message 504 can contain information about the at least one conference set-up condition to be checked). This case shall be assumed in the example described.

In yet another illustrative embodiment, it can be provided that the at least one conference set-up condition is checked by a further entity and the latter then conveys the test result to the first conference server PS1 206.

In one illustrative embodiment, the addresses are requested by the first conference server PS1 206 by means of an SIP INVITE message as availability information request message 504. The SIP INVITE message 504 contains the address of the communication group G1 as addressee. In addition, the SIP INVITE message 504 contains the feature tag ‘isfocus’. The feature tag ‘isfocus’ tells the receiving conference server, i.e. for example the second conference server PS2 218, that the second conference server PS2 218 should not be the central conference server for the conference session in this case and should invite the members of the communication group G1 but that, if necessary, the addresses of the communication group G1 should be reported back to the sender of the SIP INVITE message 504, i.e., for example, to the first conference server PS1 206 or, as an alternative, the number of available user terminals of the communication group G1. Specifying the conference set-up condition(s) in the message body of the SIP INVITE message 504 makes it possible to signal to the second conference server PS2 218 that it should check the conference set-up condition(s) and the compliance/non-compliance with the conference set-up condition(s) for the user terminal addresses of communication group G1 should be reported back to the first conference server PS1 206.

In the following pseudo code representation, the general structure of the SIP INVITE message 504 according to an illustrative embodiment is described:

INVITE sip:G1.network2.net SIP/2.0
Max-Forwards: 70
From: sip:T1@network1.net;tag+72648
To: sip:G1.network2.net
Contact:
<sip:Session1@PTTServer1.network1.net>;isfocus
Call-ID: asd88asd77a@1.2.3.4
CSeq: 1 INVITE
Content-Type: text/plain
Content-Length: 25
Number of available users

In this example, specifying “number of available users” in the message body of the SIP INVITE message 504 represents the information requested for checking the conference session set-up condition.

After receiving the availability information request message 504, the second conference server PS2 218 enquires the addresses (in the present case the user terminal addresses) of the group members of the requested communication group G1 from its responsible group management server 302. In one illustrative embodiment, the second conference server PS2 218 enquires the addresses of the group members of the requested communication group G1 from its responsible group management server 302 by generating a user terminal address request message 506 (with the user group address of communication group G1 as request parameter), for example in the form of an XCAP GET message, and conveying it to the group management server 302 which, following the reception of the user terminal address request message 506, determines the user terminal addresses allocated to the communication group G1 and conveys these in a user terminal address response message 508 generated by it (for example in the form of an XCAP OK message which contains the found user terminal addresses of the communication group G1) to the second conference server PS2 218.

After the second conference server PS2 218 has received the user terminal address response message 508 and thus determined the user terminal addresses of all desired users of the conference, the second conference server PS2 218 now enquires availability information about the reported members of communication group G1 from the presence server PRS2 304 and checks which of the received user terminal addresses are available for communication. If at least two user terminal addresses are available, generally, if the at least one predefined conference set-up condition is met (that is to say the conference set-up condition in the present example: at least two user terminals of the communication group must be available for the conference), the second conference server PS2 218 generates an availability information response message 514 which contains the test result and sends it to the first conference server PS1 206.

In one illustrative embodiment, the second conference server PS2 218 requests the availability information about the reported members of communication group G1 from the presence server PRS2 by generating a further availability information request message 510 (for example in the form of an SIP SUBSCRIBE message), the further availability information request message 510 now containing the user terminal addresses of the desired user terminals, and not a user group address, and conveying it to the presence server PRS2 304. The presence server PRS2 304 is able to determine the desired availability information with respect to the specified user terminal addresses. The presence server PRS2 304 determines the desired availability information after receiving the further availability information request message 510.

After the presence server PRS2 304 has determined the requested availability information, it generates an availability information response message 512 (for example in the form of an SIP NOTIFIY message) which contains the requested availability information, and conveys these to the second conference server PS2 218.

In one illustrative embodiment of the invention, the availability information response message 514 can be an SIP 403 ‘forbidden’ message 514 with the number of available user terminals of the communication group G1 (as an alternative with the test result, furthermore as an alternative with the user terminal addresses of the available user terminals of communication group G1).

In the following pseudo code representation, the general structure of the SIP 403 ‘forbidden’ message 514 according to an illustrative embodiment is described:

SIP/2.0 403 Forbidden
From: sip:T1@network1.net;tag+72648
To: sip:G1.network2.net
Call-ID; asd88asd77a@1.2.3.4
CSeq: 1 INVITE
Content-Type: text/plain
Content-Length: 1
2

The value “2” in the message body of the SIP 403 ‘forbidden’ message 514 specifies that, according to the present example, two user terminals of communication group G1 are currently available (which corresponds to a positive test result).

After receiving the availability information response message 514, the first conference server PS1 206 checks in 516 the conference set-up condition(s) by using the availability information about the user terminals of communication group G1 conveyed in the availability information response message 514 (as an alternative, the first conference server PS1 206 determines in 516 whether the test result is positive or not).

If the test result is positive, that is to say if at least two user terminal addresses are available, generally if the at least one predefined conference set-up condition is met (in the present example therefore the conference set-up condition: at least two user terminals of the communication group must be available for the conference), the first conference server PS1 206 sends out invitations (for example in the form of server invitation messages) to the second user terminal 214 of the second user T2 and to the available user terminal addresses of communication group G1. In addition, the first conference server PS1 206 notifies the first user terminal 210 of the first user T1 that there is an invitation to the conference session. In one illustrative embodiment, the first conference server PS1 206 sends an SIP INVITE message 524 to the second user terminal 214 of the second user T2.

The available user terminals located in the second communication network are invited by the first conference server PS1 206 generating a common or individual SIP INVITE message(s) 526 and conveying these to the second conference server PS2 218. Following the reception of the common SIP INVITE message 526, the second conference server PS2 218 generates a respective SIP INVITE message 528 and 530 for each user terminal to be invited (e.g. 220, 224) in the second communication network N2 204 and conveys these to the respective user terminals to be invited (e.g. 220, 224).

In addition, the first conference server PS1 206 notifies the first user terminal 210 of the first user T1 that there has been an invitation to the conference session, by means of a conference set-up acknowledgement message 522 (for example in the form of an SIP 200 OK message 522) which is generated by the first conference server PS1 206 and is conveyed to the first (inviting) user terminal 210 of the first user T1.

The conference session can now be established between all user terminals which accept the invitation to the conference session.

However, if it is found in the test step described above that fewer than two of the received user terminal addresses of communication group G1 are available (generally, if it is found that the at least one conference set-up condition is not met), the first conference server PS1 206 does not invite any communication users to a conference session. In addition, the first conference server PS1 206 in this case reports to the first user terminal 210 and thus to the first user T1 that there has been no invitation to the conference session since the condition(s) for this was (were) not met. If the condition(s) was (were) not met at the time of the invitation, the first communication server PS1 206, according to an illustrative embodiment, optionally checks the condition(s) again later. As soon as the condition(s) is or are met, the first communication server PS1 206 invites the users T1, T2 and the members of communication group G1 to a communication conference session.

In various illustrative embodiments, it may be provided, for checking communication session rejection conditions, to call up information needed for this from several conference servers. The several conference servers can belong to several different communication networks (of the same or different communication network operators).

To check conditions about the members of hierarchical user groups, it can be found, according to various illustrative embodiments, by enquiring presence information that the requested address belongs to a user group of another communication network. After that, the addresses of the group members are called up by one or more conference servers of the other communication network or communication networks. The addresses obtained can then be used for checking conditions about the corresponding user group members.

In one embodiment, the addresses can be requested from a communication terminal to be invited and subsequently checked by this communication terminal. In another embodiment, the addresses can be requested by the central communication conference server and subsequently checked by this communication conference server.

Instead of checking the conditions by means of the inviting communication terminal or the central communication conference server, the conditions can also be checked by several communication conference servers. In this arrangement, communication conference servers of the various communication networks involved in each case check the conditions for the users of their communication network.

Illustrative embodiments may provide for conditional communication session rejections for conditions about the users of hierarchical communication groups.

If the checking of the conditions is distributed to a number of communication conference servers, this can also have the consequence that the processing effort does not have to be produced by a single communication conference server or a single communication terminal. This may relieve the central communication conference server or the communication terminal, respectively.

If the checking of the conditions is distributed to a number of communication conference servers, this can also have the consequence that these communication conference servers only need to be authorized to call up relevant presence information about users of their communication network. It is not required that all communication conference servers of all communication networks are authorized to call up presence information from all communication networks.

As has been described above, communication conference sessions may be initiated conditionally. It is possible that such communication conference sessions are started only if the predefined conditions are met. The conditions may relate to information about hierarchical communication groups. The conditions may also relate to information which comes from several different communication networks.

If the condition(s) for the starting of the communication conference session is or are not met at the time of the invitation, it may also be provided that the central conference server does not again check the condition(s) and does not issue invitations to the conference session later when the condition(s) is or are met. The question of whether it is necessary to check again can be established with the condition or conditions (in the invitation or in the definition of the communication group to be invited).

It may also be provided, before the enquiry of presence information or address information, to establish by means of the central conference server whether an address to be invited identifies a communication group. If it is found that a communication group is identified, the request of presence information relating to communication group G1 can be omitted and, instead, the addresses of the group members may immediately be requested by the PTT server PS2. It may be provided to enquire from the second conference server PS2 with a special SIP message whether the communication group G1 is a group, or it can be provided to establish by means of the format of the address of the communication group G1 whether the communication group G1 is really a group. Instead of reporting back the number of available addresses from the second conference server PS2 218 to the first conference server PS1 206 in the above second example, it can also be provided to report back the available user terminal addresses. In this case, the user terminal addresses no longer need to be requested in a further step.

Instead of enquiring by SIP INVITE message whether condition(s) have been met, the enquiry can also be made by SIP SUBSCRIBE/NOTIFY messages. The notifications by SIP NOTIFY messages can be made once or whenever the condition(s) changes or change. The latter can be appropriately used for repeatedly checking the condition(s).

Instead of enquiring the addresses of group members by SIP INVITE message, the enquiry may also be made by SIP SUBSCRIBE/NOTIFY messages. The notifications by SIP NOTIFY messages may be made once or whenever the addresses change. The latter can be appropriately used for repeatedly checking the conditions.

Instead of using SIP INVITE messages or SIP SUBSCRIBE/NOTIFY messages for enquiring addresses or conditions, the enquiry may also be made with a special new SIP message which is defined or can be used specially for this purpose.

Instead of using conference session invitations and enquiries SIP, other protocols can also be used, for example those described above.

It should be pointed out that the illustrative embodiments are not restricted to PoC systems but that it can also be used in other PTT systems or generally in other conference systems.

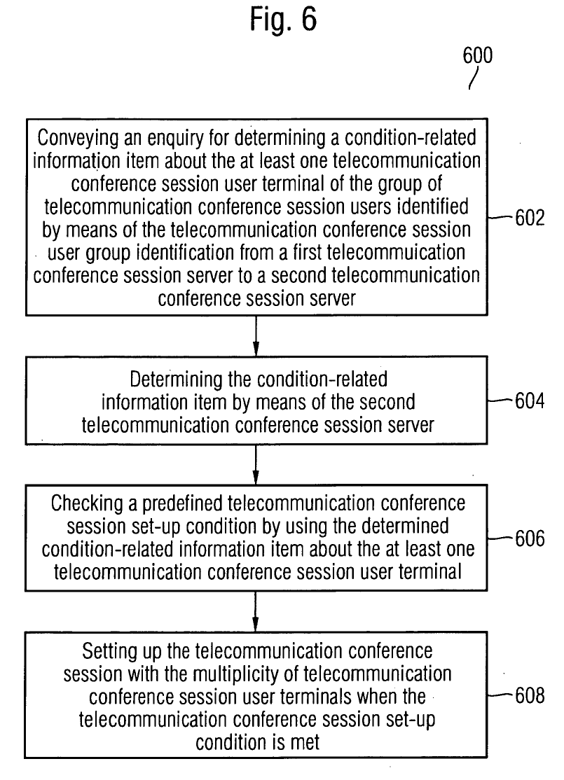

FIG. 6 shows a flowchart 600 in which a method for the conditional setting-up of a telecommunication conference session with a multiplicity of telecommunication conference session user terminals according to another illustrative embodiment is shown, wherein a group of user terminals having at least one telecommunication conference session user terminal is identified by means of a telecommunication conference session user group identification.

In 602, an enquiry for determining a condition-related information item about the at least one telecommunication conference session user terminal of the telecommunication conference session user group identified by means of the telecommunication conference session user group identification may be conveyed from a first telecommunication conference session server to a second telecommunication conference session server.

In 604, the condition-related information item may be determined by means of the second telecommunication conference session server.

In 606, a predefined telecommunication conference session set-up condition may be checked by using the determined condition-related information item about the at least one telecommunication conference session user terminal.

Furthermore, in 608 the telecommunication conference session with the multiplicity of telecommunication conference session user terminals may be set up if the telecommunication conference session set-up condition is met.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method for the conditional setting-up of a telecommunication conference session with a multiplicity of telecommunication conference session user terminals, the method comprising:
conveying an enquiry for determining a condition-related information item about the at least one telecommunication conference session user terminal of the telecommunication conference session user group identified by means of a telecommunication conference session user group identification from a first telecommunication conference session server to a second telecommunication conference session server, wherein a group of user terminals having at least one telecommunication conference session user terminal is identified by means of the telecommunication conference session user group identification;
determining the condition-related information item by means of the second telecommunication conference session server;
checking a predefined telecommunication conference session set-up condition by using the determined condition-related information item about the at least one telecommunication conference session user terminal; and
setting up the telecommunication conference session with the multiplicity of telecommunication conference session user terminals if the telecommunication conference session set-up condition is met.

2. The method of claim 1,
wherein the telecommunication conference session is a half-duplex telecommunication conference session.

3. The method of claim 2,
wherein the telecommunication conference session is a push-to-talk telecommunication conference session.

4. The method of claim 1,
wherein the telecommunication conference session is an Internet-based telecommunication conference session.

5. The method of claim 1,
wherein the communication session is set up by using at least one telecommunication conference control message according to a telecommunication conference control protocol.

6. The method of claim 1,
wherein the telecommunication conference control protocol is a protocol selected from a group of protocols consisting of:
Session Initiation Protocol;
Real Time Transport Control Protocol; and
Binary Floor Control Protocol.

7. The method of claim 1,
wherein the first telecommunication conference session server and the second telecommunication conference session server are arranged in different telecommunication networks.

8. The method of claim 1,
wherein the telecommunication conference session user group identification identifies a multiplicity of telecommunication conference session user terminals grouped to form the user group.

9. The method of claim 1,
wherein the group identified by means of the telecommunication conference session user group identification comprises an additional telecommunication conference session user group identification which identifies at least one additional telecommunication conference session user terminal.

10. The method of claim 1,
wherein an enquiry for availability information of the at least one telecommunication conference session user terminal, which is identified by means of the telecommunication conference session user group identification, is sent to a presence server which is arranged in a different telecommunication network from the first telecommunication conference session server.

11. The method of claim 1,
wherein the condition-related information item includes at least one item selected from a group of items consisting of:
at least one telecommunication conference session user terminal address which identifies the at least one telecommunication conference session user terminal;
an information item about the number of available telecommunication conference session user terminals;
an information item about a spatial location area of at least one telecommunication conference session user terminal; and
an information item about the availability of at least one predefined telecommunication conference session user terminal.

12. The method of claim 1,
wherein the condition-related information item is conveyed to the first telecommunication conference session server.

13. The method of claim 1,
wherein the result of the check of the telecommunication conference session set-up condition is conveyed to the first telecommunication conference session server.

14. The method of claim 1,
wherein the first telecommunication conference session server checks the predefined telecommunication conference session set--up condition.

15. The method of claim 1
wherein the condition-related information item is conveyed by the second telecommunication conference session server to a test circuit; and
wherein the test circuit checks the predefined telecommunication conference session set-up condition.

16. A telecommunication conference session server for the conditional setting-up of a telecommunication conference session with a multiplicity of telecommunication conference session user terminals, the telecommunication conference session server comprising:
an enquiry-generating circuit configured to generate an enquiry for determining a condition-related information item about the at least one telecommunication conference session user terminal of the telecommunication conference session user group identified by means of a telecommunication conference session user group identification, wherein a group of user terminals having at least one telecommunication conference session user terminal is identified by means of the telecommunication conference session user group identification; and
a transmitter configured to transmit the enquiry to another telecommunication conference session server.

17. The telecommunication conference session server of claim 16,
arranged for communication in accordance with a half-duplex telecommunication conference session.

18. The telecommunication conference session server of claim 16,
configured to set up the communication session by using at least one telecommunication conference control message according to a telecommunication conference control protocol.

19. The telecommunication conference session server of claim 18,
wherein the telecommunication conference control protocol is a protocol selected from a group of protocols consisting of:
Session Initiation Protocol;
Real Time Transport Control Protocol; and
Binary Floor Control Protocol.

20. The telecommunication conference session server of claim 16,
wherein the group identified by means of the telecommunication conference session user group identification comprises an additional telecommunication conference session user group identification which identifies at least one additional telecommunication conference session user terminal.

21. The telecommunication conference session server of claim 16, further comprising:
an enquiry-message-generating circuit, wherein the enquiry message comprises an enquiry for availability information of the at least one telecommunication conference session user terminal which is identified by means of the telecommunication conference session user group identification;
wherein the transmitter is configured to transmit the enquiry message to a presence server which is arranged in a different telecommunication network from the first telecommunication conference session server.

22. A method for generating an enquiry for the conditional setting-up of a telecommunication conference session with a multiplicity of telecommunication conference session user terminals, the method comprising:
generating an enquiry for determining a condition-related information item about the at least one telecommunication conference session user terminal of the telecommunication conference session user group identified by means of a telecommunication conference session user group identification by a telecommunication conference session server, wherein a group of user terminals having at least one telecommunication conference session user terminal is identified by means of the telecommunication conference session user group identification.

23. A telecommunication conference session server for the conditional setting-up of a telecommunication conference session with a multiplicity of telecommunication conference session user terminals, the telecommunication conference session server comprising:
a receiver configured to receive an enquiry for determining a condition-related information item about the at least one telecommunication conference session user terminal of the telecommunication conference session user group identified by means of a telecommunication conference session user group identification from another telecommunication conference session server, wherein a group of user terminals having at least one telecommunication conference session user terminal is identified by means of the telecommunication conference session user group identification; and
a determination circuit configured to determine the condition-related information item.

24. The telecommunication conference session server of claim 23,
arranged for communication in accordance with a half-duplex telecommunication conference session.

25. A method for determining a condition-related information item for the conditional setting-up of a telecommunication conference session with a multiplicity of telecommunication conference session user terminals, the method comprising: receiving an enquiry for determining a condition-related information item about the at least one telecommunication conference session user terminal of the telecommunication conference session user group identified by means of a telecommunication conference session user group identification from another telecommunication conference session server, wherein a group of user terminals having at least one telecommunication conference session user terminal is identified by means of a telecommunication conference session user group identification; and
determining the condition-related information item by a telecommunication conference session server receiving the enquiry.
